(19) United States
(12) Patent Application Publication
(10) Pub. No.: US 2002/0098118 A1
(43) Pub. Date: Jul. 25, 2002

(54) Apparatus for treating objects

(75) Inventors: Ralf Eckert, Dossenheim (DE); Charilaos Dalkidis, Schwetzingen (DE); Stefan Kuenkel, Karlsruhe (DE); Stefan Thiem, Heidelberg (DE)

Correspondence Address: SIMPSON & SIMPSON, PLLC, 5555 MAIN STREET, WILLIAMSVILLE, NY, 14221-5406, US

(73) Assignee: Leica Microsystems Nussloch GmbH, Nussloch (DE)

(21) Appl. No.: 10/011,674

(22) Filed: Oct. 22, 2001

(30) Foreign Application Priority Data
Oct. 23, 2000 (DE) 100 52 503.2

(51) Int. Cl. G01N 35/00

(52) U.S. Cl. 422/65; 422/104; 436/174

(57) ABSTRACT

An apparatus for treating objects, in particular cytological or histological specimens, having multiple processing stations (2) and a transport device (4) for delivering the objects into and out of the processing stations (2), the processing station (2) comprising a container (3) for receiving liquids, in particular reagents, and for immersion of the objects or of the object holders (7) carrying the objects, is characterized, in order to increase the flexibility of the apparatus, in that an insert (8) that fits into the container (3) and reduces the maximum capacity of the container (3) is provided, a rack (7) that carries the object carrier (9) and serves for immersion into the container (3) being adapted in terms of its dimensions in accordance with the remaining volume.

### CROSS REFERENCE TO RELATED APPLICATIONS

This invention claims priority of the German patent application 100 52 503.2 filed Oct. 23, 2000 which is incorporated by reference herein.

### FIELD OF THE INVENTION

The invention concerns an apparatus for treating objects, in particular cytological or histological specimens, having multiple processing stations and a transport device for delivering the objects into and out of the processing stations, the processing station comprising a container for receiving liquids, in particular reagents, and for immersion of the objects or of the object holders carrying the objects.

### BACKGROUND OF THE INVENTION

Apparatuses of the generic type are known from a wide variety of sectors. Very generally, they are apparatuses used for the manipulation and/or processing of objects of any kind. The objects are conveyed, usually in a predefined sequence, either to a single processing station or to multiple processing stations, processed therein, and then lastly transported away from the processing station, in which context different groups of processing stations can be arranged behind and/or next to one another.

The reader is referred, merely by way of example, to EP 0 849 582 A1. This document discloses an apparatus for treating objects, in particular cytological or histological specimens. In it, cytological or histological specimens are conveyed to an automatic stainer by means of an object carrier or basket (often also called a “rack” in technical terminology), the stainer comprising multiple processing stations.

The known apparatus is problematic, however, in that the processing stations are all equipped with containers of the same size for receiving reagents. This is not a problem in the case of standard staining operations, especially since using so-called racks, object carriers carrying 20 to 30 objects are usually immersed. A corresponding level of reagents is guaranteed in the conventional containers. But if special staining operations using complex and thus expensive reagents are to be performed, the use of conventional containers to receive the reagents is problematic, especially since object carriers carrying only a few objects usually need to be immersed. Irrespective of this smaller number of object carriers, however, the same quantity of liquid or reagent must be made available in order to ensure proper immersion of the object carriers. This is problematic given the high price of the staining solutions, and not justifiable in terms of the resulting costs.

### SUMMARY OF THE INVENTION

It is therefore the object of the present invention to configure and develop an apparatus for treating objects, in particular cytological or histological specimens, in such a way as to make additionally possible, in particular, the treatment of small numbers of objects at acceptable material cost.

The object is achieved by improving a generic apparatus for treating objects, in particular cytological or histological specimens, by providing an insert that fits into the container and reduces the maximum capacity of the container, and adapting a rack that carries the object carrier and serves for immersion into the container in terms of its dimensions in accordance with the remaining volume.

What has been recognized according to the present invention is that the conventional containers can by all means be used even if only a small number of object carriers need to be immersed into the liquid. This situation is dealt with, according to the present invention, by the fact that the maximum capacity of the container is reduced, specifically by way of an insert that fits into the container. Corresponding to the reduction in the capacity of the container hereby achieved, the rack carrying the object carriers or objects and serving for immersion into the container is adapted in terms of its dimensions in accordance with the remaining volume in the container. In other words, a very particular insert serves to reduce the maximum capacity of the container, in which context it must be ensured that the object carriers carrying the objects can be completely immersed into the remaining volume of the container. A modification of the container is thus created here, by which the volume serving to receive reagents is reduced in such a way that only a substantially smaller quantity of liquid or staining solution is necessary. Material costs are thereby effectively reduced. It is moreover possible, even with the reduced quantity of staining solution, to use the same containers, specifically with a corresponding insert.

Concretely, the insert could be configured as a displacement body, so that it serves solely to reduce the volume of liquid. In this context, the insert could be placed into the container or suspended at its rim into the container.

In the context of a very particularly advantageous embodiment, it is possible for the insert to comprise at least one reduced reagent vessel and positioning means for secure immersion into the container. In the context of such an embodiment, the insert would be configured as a smaller container that can be inserted, placed, or suspended into the larger container. The positioning means provide a secure fit into the container so that it cannot tilt therein and moreover is arranged at a defined point. The container or the reagent vessel inserted therein could correspondingly be loaded with a reduced number of object carriers that are inserted into the reagent vessel via the transport device and with the aid of the rack.

In the context of a particularly simple embodiment, the positioning means are dimensioned and designed in such a way that the reagent vessel can be positioned approximately centeredly in the container. An at least slight jamming effect between the positioning means and the inner wall of the container could be brought about. It is also conceivable for the positioning means to be configured as ribs, flanges, or the like that are at least largely adapted to the inner wall of the container; in the context of a further advantageous embodiment, the container can comprise particular receptacles, guides, or the like for the positioning means.

Be it noted at this juncture that the insert can by all means also comprise two reagent vessels separated from one another, and that different staining solutions can be used simultaneously by way of these two reagent vessels. If a greater immersion volume should be necessary, in that case both reagent vessels can be simultaneously filled with identical staining solutions.

When the insert is used according to the present invention to reduce the container volume, it is of further advantage if the rack used for operation of the reduced reagent vessel comprises a reduced number of receiving positions for object carriers, specifically so that the rack together with the object carriers fits into the reagent vessel. Concretely, the rack could be equipped with three to eight, preferably five receiving positions for object carriers, a coordination between the dimensions of the reagent vessel and the arrangement of the object carriers being necessary. With optimum coordination, material costs relevant to the requisite staining solution can be very considerably reduced.

The receiving positions of the rack (for receiving the object carriers carrying the objects) can be arranged and designed in such a way that the object carriers are held on end or vertically and can be immersed, positioned accordingly, into the reagent vessel. The object carriers are preferably arranged parallel to one another so that the space requirement is thereby optimized. It is advantageous in any event if, in accordance with the utilization or reagent vessel that is concretely used, correspondingly designed (and preferably exchangeable) racks are available. These can be allocated to the transport device as desired.

The container can be any desired processing station of the apparatus, for example a conventional reagent station. It is also conceivable for the container to be a heated reagent station whose volume can similarly be reduced by means of an insert.

### BRIEF DESCRIPTION OF THE DRAWINGS

There are various ways of advantageously embodying and developing the teaching of the present invention. The reader is referred, for that purpose, to the present specification, including the explanation below of a preferred exemplary embodiment of the invention with reference to the drawings. In conjunction with the explanation of the preferred exemplary embodiment of the invention with reference to the drawings, an explanation is also given of generally preferred embodiments and developments of the teaching. In the drawings:

FIG. 1 schematically depicts the general configuration of an apparatus according to the present invention, using the example of an automatic stainer;

FIG. 2 shows, in a schematic perspective view, an insert for reducing the maximum capacity of the container that is used in the automatic stainer of FIG. 1;

FIG. 3 shows, in a schematic perspective view, a container of the apparatus of FIG. 1, the insert as shown in FIG. 2 being inserted therein;

FIG. 4 shows, in perspective in a schematic side view, an exemplary embodiment of a rack matching the insert and the reagent vessel of the insert; and

FIG. 5 shows, in a schematic view, the container of FIG. 3 with an insert and inserted rack, only one object carrier being held therein.

### DETAILED DESCRIPTION OF THE INVENTION

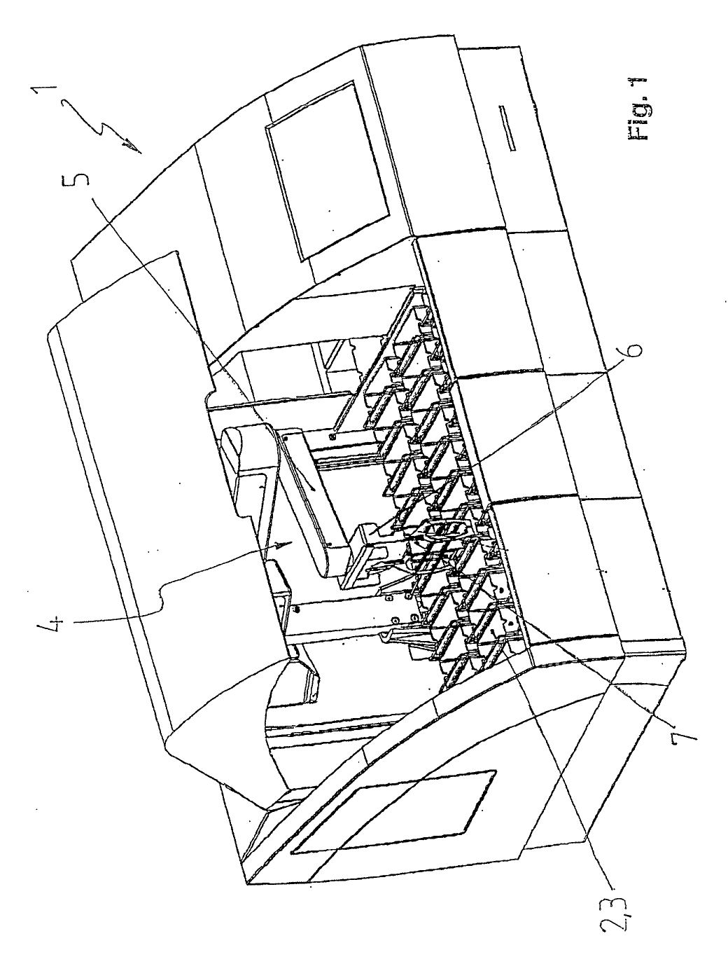

FIG. 1 shows, in a schematic view, an exemplary embodiment of an apparatus according to the present invention for treating cytological or histological specimens, this being concretely an automatic stainer 1. Regarding the basic configuration of an automatic stainer, the reader is referred to EP 0 849 582 A2.

Automatic stainer 1 comprises multiple processing stations 2, these being defined here by containers 3 for liquids or reagents.

Also provided is a transport device 4 that moves objects (not shown in the Figures) into and out of processing stations 2.

Transport device 4 comprises a robot arm 5 that is movable in three dimensions and serves to position the objects as desired. This robot arm 5 ensures that transport device 4 is as flexible as possible, specifically in such a way that the objects can be positioned as desired in three dimensions, i.e. concretely within the apparatus.

It is further evident from FIG. 1 that robot arm 5 comprises at its free end a gripper 6 for receiving the objects or an object holder 7, object holder 7 being referred to hereinafter, for the sake of simplicity, as a rack. The objects are delivered into container 3 together with rack 7, and are also moved back out of container 3 together with rack 7.

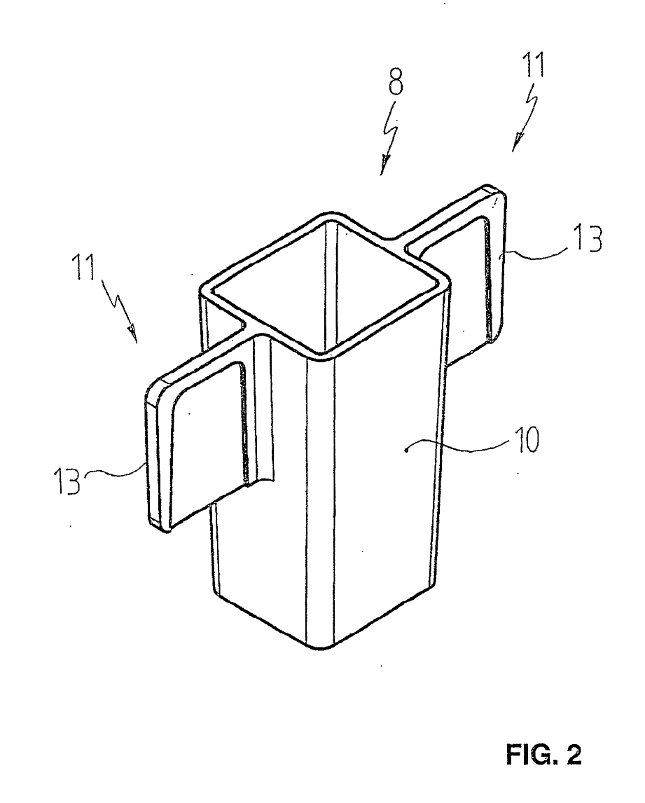

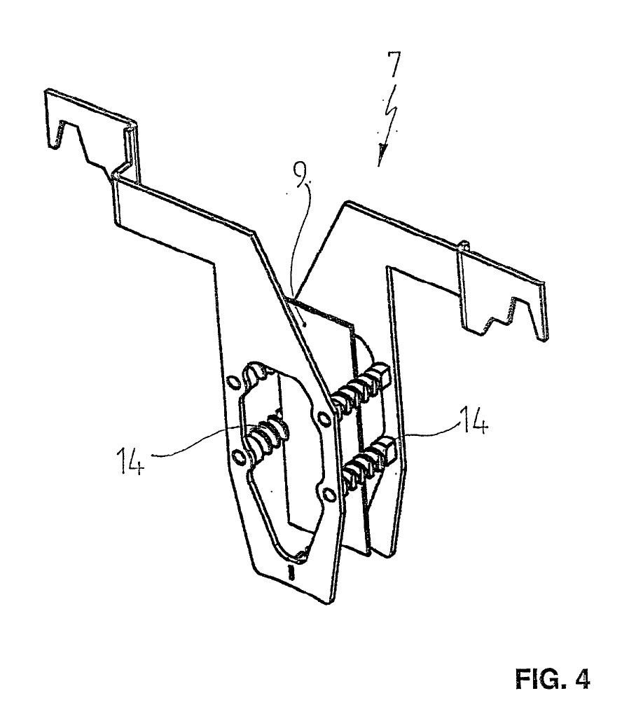

According to the present invention an insert 8, which fits into container 3 and reduces the maximum capacity of container 3, is provided. This insert 8 is depicted in isolation in FIG. 2. Rack 7, which carries object carriers 9 and serves for immersion into container 7, is adapted in terms of its dimensions in accordance with the remaining volume. A rack 7 of this kind is depicted in isolation in FIG. 4.

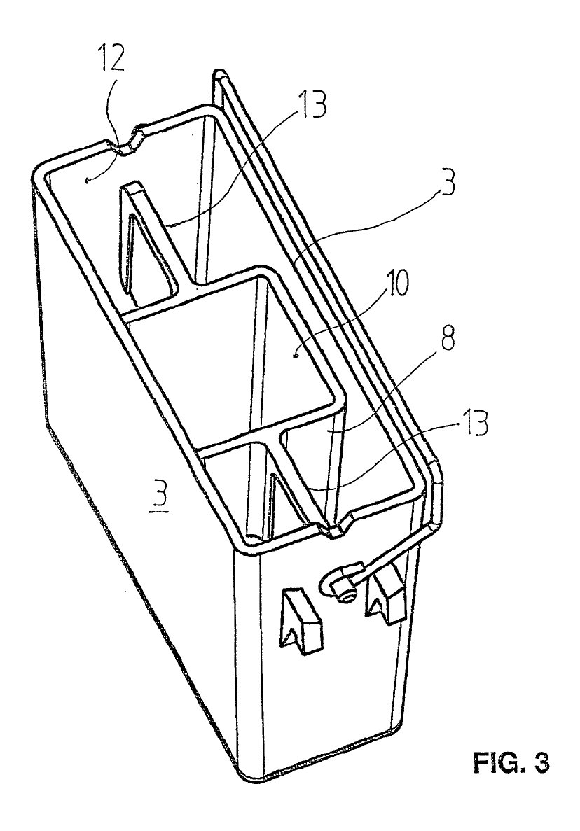

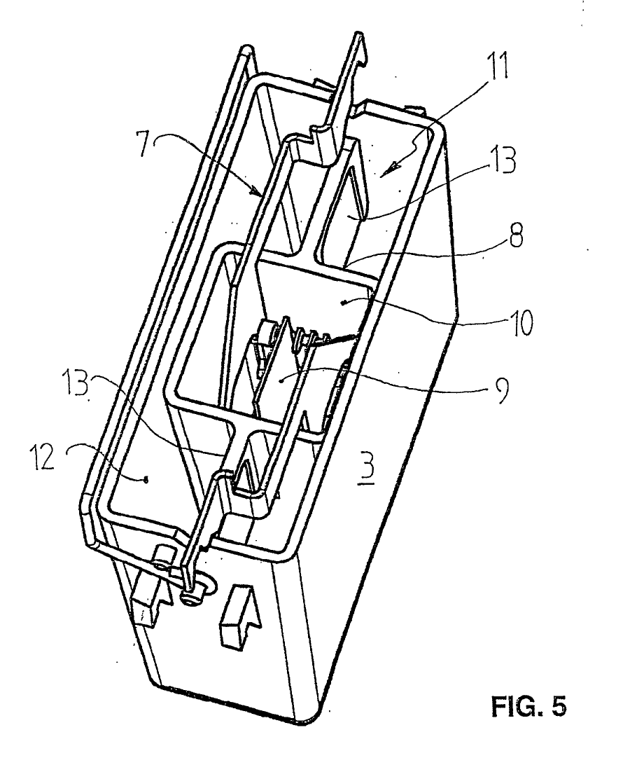

FIGS. 2 and 3 together show that insert 8 is designed for placement into container 3, insert 8 comprising a reduced reagent vessel 10 and positioning means 11 for a secure fit into container 3. Positioning means 11 are dimensioned and designed in such a way that reagent vessel 10 is positioned approximately centeredly in container 3. This is very particularly evident from FIGS. 3 and 5.

FIGS. 2, 3, and 5 furthermore show clearly that positioning means 11 are configured as flanges 13 adapted to inner wall 12 of container 3, thus ensuring constrained positioning of insert 8 with a centered orientation of reagent vessel 10.

Rack 7 shown in FIG. 4 is used for operation or loading of the reduced reagent vessel 10, and for that purpose comprises a reduced number of receiving positions 14 for object carriers 9. In the depiction of FIG. 5, insert 8 with reagent vessel 10 and positioning means 11 or flanges 13 is inserted into vessel 3. Rack 7 having a reduced number of receiving positions 14 is also inserted or positioned; in the depiction selected for FIG. 5, only one object carrier 9 is carried by rack 7. This promotes a simple and clear illustration.

It is moreover evident from FIGS. 4 and 5 that receiving positions 14 are arranged and designed in such a way that object carriers 9 are held, and can be immersed into reagent vessel 10, on end or vertically, as indicated in particular in FIG. 5.

Lastly, let it be noted that container 3 shown here can be the container of a conventional reagent station but also container 3 of a heated reagent station. In any event, an effective reduction is achieved in the volume of container 3 that serves to receive reagents, specifically by the use according to the present invention of an insert 8 having a corresponding reagent vessel 10.

Lastly, let it be noted that the exemplary embodiment discussed above serves for discussion of the teaching claimed but does not limit the latter to the exemplary embodiment.

### PARTS LIST

1 Automatic stainer

2 Processing station, treatment station

3 Container

4 Transport device

5 Robot arm

6 Gripper

7 Object holder/rack

8 Insert

9 Object carrier

10 Reagent vessel

11 Positioning means

12 Inner wall (of container)

13 Flange (of insert)

14 Receiving position (in rack)

What is claimed is:

1. In an apparatus for treating objects, in particular for cytological or histological specimens, having multiple processing stations (2) and a transport device (4) for delivering said objects into and out of said processing stations (2), each of said multiple processing stations (2) comprising a container (3) for receiving liquid reagents, and for immersion of said objects or of a rack (7) carrying a plurality of said objects, the improvement comprising:
an insert (8) that fits into said container (3), said insert (8) reducing the maximum capacity of said container (3); and
said rack (7) being sized for receipt by said reduced maximum capacity of said container (3).

2. The improvement as recited in claim 1, wherein said insert (8) is designed for suspension within said container (3).

3. The improvement as recited in claim 1, wherein said insert (8) is designed for placement into said container (3).

4. The improvement as recited in claim 1, wherein said insert (8) comprises at least one reduced reagent vessel (10) and positioning means (11) for securing said insert (8) within said container (3).

5. The improvement as recited in claim 4, wherein said positioning means (11) positions said reagent vessel (10) approximately centered in said container (3).

6. The improvement as recited in claim 5, wherein said positioning means (11) includes a pair of flanges (13) that extend from said reagent vessel for engagement with a pair of opposing surfaces of an inner wall (12) of said container (3).

7. The improvement as recited in claim 5, wherein said positioning means (11) includes a pair of opposite outer walls of said insert (8) that engage a pair of opposing surfaces of an inner wall (12) of said container (3).

8. The improvement as recited in claim 4, wherein said container (3) comprises guide means to accept said positioning means (11) of said insert (8).

9. The improvement as recited in claim 1, wherein said rack (7) comprises a reduced number of receiving positions (14) for said plurality of objects.

10. The improvement as recited in claim 9, wherein said rack (7) has a total number of said receiving positions (14) ranging from three to eight.

11. The improvement as recited in claim 10, wherein said rack (7) has a total number of said receiving positions (14) equal to five.

12. The improvement as recited in claim 9, wherein said receiving positions (14) hold a plurality of elongated object carriers (9).

13. The improvement as recited in claim 9, wherein said receiving positions (14) hold said object carriers (9) such that said object carriers (9) can be immersed into said reagent vessel (10) with a longitudinal axis of said object carrier in a vertical orientation. reagent vessel (10) with a longitudinal axis of said object carrier in a horizontal orientation.

15. The improvement as recited in claim 1, wherein said container (3) is a conventional reagent station.

16. The improvement as recited in claim 1, wherein said container (3) is a heated reagent station.

17. An apparatus for reducing the volume of a reagent container (3) for treatment of specimens comprising:
an insert (8) that fits into said container (3), said insert (8) cooperating with said container (3) to reduce the maximum capacity of said container (3), and said insert (8) defining an opening for receiving a rack (7) by immersion.

18. A method for reducing the volume of a reagent container (3) for treatment of specimens comprising the steps of:
(a) placing an insert (8) into said containers (3), said insert (8) cooperating with said container (3) to reduce maximum volume of said container (3); and
(b) immersing a plurality of said specimens into said reduced volume of said container (3).

19. An apparatus for reducing the volume of a reagent container (3) for treatment of specimens comprising:
an insert (8) that reduces the maximum capacity of said container (3) without preventing a rack (7) from being immersed into said reagent.

20. The apparatus as recited in claim 19 wherein said insert (8) includes a wall.

21. The apparatus as recited in claim 20 wherein said wall defines a volume less than the maximum volume of said container (3), said volume operatively arranged to receive said rack (7).

22. The apparatus as recited in claim 21, wherein said insert (8) further comprises at least one reduced reagent vessel (10) and positioning means (11) for securing said insert (8) within said container (3).

23. The improvement as recited in claim 22, wherein said positioning means (11) positions said reagent vessel (10) approximately centered in said container (3).

24. The apparatus as recited in claim 22, wherein said positioning means (11) includes a pair of flanges (13) that extend from said reagent vessel for engagement with a pair of opposing surfaces of an inner wall (12) of said container (3).

25. The apparatus as recited in claim 22, wherein said positioning means (11) includes a pair of opposite outer walls of said insert (8) that engage a pair of opposing surfaces of an inner wall (12) of said container (3).

26. The apparatus as recited in claim 22, wherein said container (3) comprises guide means to accept said positioning means (11) of said insert (8).
